(19) United States
(12) Patent Application Publication
(10) Pub. No.: US 2023/0229051 A1
(43) Pub. Date: Jul. 20, 2023

(54) METHOD AND DEVICE FOR CONTROLLING STATES OF DYNAMIC GLASS

(71) Applicant: FURCIFER INC., FREMONT, CA (US)

(72) Inventors: JIAN WANG, FREMONT, CA (US); GUANGMING WANG, HUNTINGTON BEACH, CA (US); YAN ZHOU, FREMONT, CA (US)

(21) Appl. No.: 17/577,538

(22) Filed: Jan. 18, 2022

(51) Int. Cl. G02F 1/163; G02F 1/1523; G02F 1/1516

(52) U.S. Cl. CPC G02F 1/163; G02F 1/1525; G02F 1/15165; G02F 1/155

(57) ABSTRACT

The disclosure relates generally to a method of changing an optical state of an electrochromic device. The method may include: selecting a desired optical state of the electrochromic device; determining a driving power to change the optical state based on an initial state and the desired state of the electrochromic device. The driving power comprises a first magnitude and a second magnitude, and the first magnitude is larger than the second magnitude. The method may further include: applying the driving power with the first magnitude to the electrochromic device for a period of time t; and at time t, switching the driving power to the second magnitude.

### TECHNICAL FIELD

The present disclosure relates generally to electrochromic materials, and in particular, to methods and devices for controlling optical states of an electrochromic device.

### BACKGROUND

Electrochromism is a phenomenon displayed by electrochromic materials of reversibly changing optical properties by using bursts of charges to cause electrochemical redox (reduction and oxidation) reactions in electrochromic materials. The optical properties may include transmittance, reflectance, absorptance and emittance. The electrochromic material may exhibit changes of optical states. The optical state of an electrochromic material may refer to lightness, transparency, color, reflectance, etc.

Electrochromic technology has been widely used in dynamic glass for its advantages of low cost and energy saving properties. Such dynamic glass is widely installed as smart windows in commercial buildings. However, the electrochromic material based dynamic glass may have slow transmission speed issues. Under the driving force of an external voltage, the ions inside electrolyte are injected into or extracted from the electrochromic materials, causing the dynamic glass to change its transmittance, reflectance, absorptance or emittance. Thus, how fast the ions can move from the electrolyte toward the electrochromic material or vice versa may influence the speed of the dynamic glass transferring from one optical state to another.

Since the ions are driven by the electric field, for example, under an external voltage, a higher external voltage will lead to a faster transmission speed. However, an electrochromic material has an electrochemical window that is the electrode electric potential range between which the electrochromic material is neither oxidized nor reduced. Thus, a high driving voltage might exceed the window, damaging the functional materials and shortening the lifetime of the dynamic glass.

Therefore, methods of increasing the transmission speed of dynamic glass while retaining its stability is highly desired. In this disclosure, we propose our methods of increasing the optical state transmission speed and stability of electrochromic materials.

### SUMMARY

One aspect of the present disclosure is directed to a method of changing an optical state of an electrochromic device. The method may include: selecting a desired optical state of the electrochromic device; determining a driving power to change the optical state based on an initial state and the desired state of the electrochromic device. The driving power comprises a first magnitude and a second magnitude, and the first magnitude is larger than the second magnitude. The method may further include: applying the driving power with the first magnitude to the electrochromic device for a period of time t; and at time t, switching the driving power to the second magnitude.

Another aspect of the present disclosure is directed to a controller for changing an optical state of an electrochromic device. The controller may include a signal receiver, a power converter, and a power output control. The signal receiver may be configured to receive signals sent to the controller. The power converter may be configured to convert an input power from a power source to a power required by the signal receiver. The power output control may be configured to receive the converted power from the power converter and provide a driving power to the electrochromic device to change the optical state of the electrochromic device from an initial state to a desired state. The driving power comprises a first magnitude and a second magnitude. The first magnitude is larger than the second magnitude. To provide the driving power to the electrochromic device, the power output control may be further configured to: apply the driving power with the first magnitude to the electrochromic device for a period of time t; and at time t, switch the driving power to the second magnitude.

Another aspect of the present disclosure is directed to an electrochromic device. The electrochromic device may include two transparent substrates; two adhesive layers disposed on the inner surfaces of the two transparent substrates; an electrochromic film disposed between the two adhesive layers, the electrochromic film including an electrochromic material layer, a solid polymer electrolyte, and a charge storage layer; and a controller configured to provide a driving power to the electrochromic device to change an optical state of the electrochromic device from an initial state to a desired state. The driving power comprises a first magnitude and a second magnitude, and the first magnitude is larger than the second magnitude. To provide the driving power to the electrochromic device, the controller may be configured to: apply the driving power with the first magnitude to the electrochromic device for a period of time t; and at time t, switch the driving power to the second magnitude.

Other objects, features and advantages of the described embodiments will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

Preferred and non-limiting embodiments of the invention may be more readily understood by referring to the accompanying drawings in which:

FIG. 1 is a graphical presentation illustrating a simplified schematic of an electrochromic device, consistent with exemplary embodiments of the present disclosure.

FIG. 2 is a sectional view of a simplified schematic of an electrochromic device, consistent with exemplary embodiments of the present disclosure.

FIG. 3 is a graphical presentation illustrating a transmission of an electrochromic device under an external voltage, consistent with exemplary embodiments of the present disclosure.

FIG. 4 is a graph illustrating an exemplary electrochromic device transferring from a dark state to a clear state under two different external voltages, consistent with exemplary embodiments of the present disclosure.

FIG. 5 is a graph illustrating transmission of an exemplary electrochromic device in a plurality of switching cycles under two different external voltages, consistent with exemplary embodiments of the present disclosure.

FIG. 6 is a graph illustrating an exemplary external voltage waveform applied to an electrochromic device, consistent with exemplary embodiments of the present disclosure.

FIG. 7 is a graph illustrating transmission of an exemplary electrochromic device under different external voltages, consistent with exemplary embodiments of the present disclosure.

FIG. 8 is a graphical presentation illustrating a controller, consistent with exemplary embodiments of the present disclosure.

### DETAILED DESCRIPTION OF THE PREFERRED EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of but a small number of embodiments within the scope of the present invention. Various changes and modifications obvious to one skilled in the art to which the present invention pertains are deemed to be within the spirit, scope and contemplation of the present invention as further defined in the appended claims.

Unless the context requires otherwise, throughout the present specification and claims, the word “comprise” and variations thereof, such as, “comprises” and “comprising” are to be construed in an open, inclusive sense, that is as “including, but not limited to”. Numeric ranges are also inclusive of the numbers defining the range. Additionally, the singular forms “a”, “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

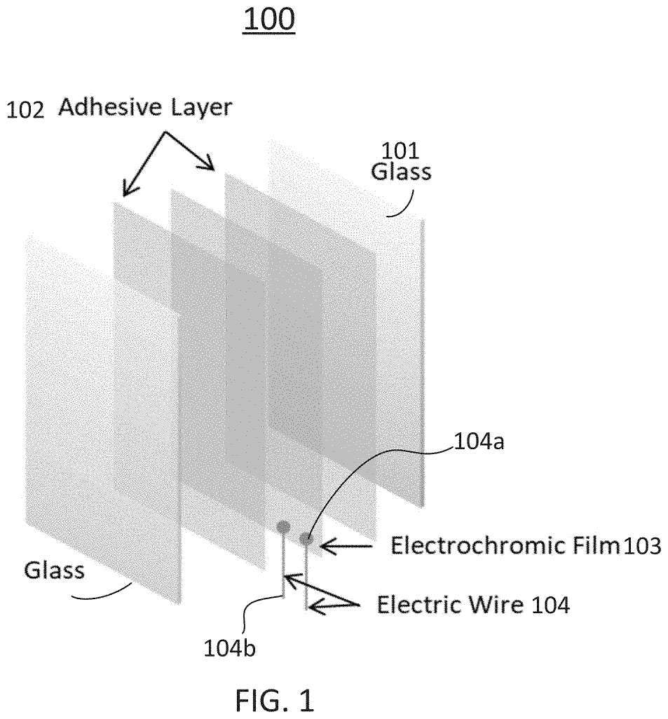

Electrochromic materials are commonly used in electrochromic devices (EC devices). FIG. 1 is a graphical illustration showing a simplified schematic of an EC device 100 (e.g., a smart window), consistent with exemplary embodiments of the present disclosure. The EC device 100 may include two layers of transparent substrates 101 (e.g., glass), two adhesive layers 102, an electrochromic film 103, one or more electric wires 104, and a controller 105 (not shown in FIG. 1).

The electrochromic film 103 is sandwiched between the two layers of the transparent substrates 101 (e.g., glass). The adhesive layers 102 are configured to attach the electrochromic film 103 to the layers of glass 101. The integration of the electrochromic film 103 with the window (layers of glass 101) is described in details in U.S. Pat. No. 10,392,301 B2, issued on Aug. 27, 2019, which is incorporated herein by reference.

One end 104a of the electric wires 104 is electrically connected to the electrochromic film 103. The other end 104b of the electric wires 104 is electrically connected to the controller 105. The controller 105 may be configured to control the state of the EC device 100 by controlling the states of the electrochromic film 103. The controller 105 may be placed outside the glass 101, or laminated between the two layers of glass 101 similar to the electrochromic film 103.

In some embodiments, the adhesive layers 102 may include a polymeric material, particularly a thermosetting polymer material. Suitable thermoset polymer materials may include, but are not limited to, polyvinyl butyral (PVB), ethylene-vinyl acetate (EVA), polyurethanes, ionoplast polymer (SentryGlas), etc. In some embodiments, the two adhesive layers may comprise a material that not only is configured to bond the electrochromic film thereto, but is also transparent. The two adhesive layers may use the same materials or different materials.

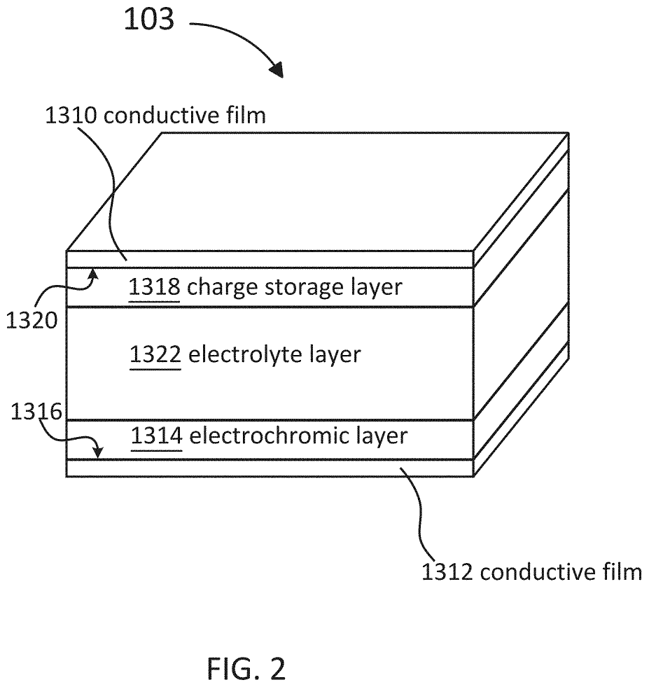

The electrochromic film 103 comprises a solid electrolyte disposed therein, according to one embodiment. The detailed structure of the electronic film 103 is shown in FIG. 2 and described in detail below.

The exemplary EC device 100 shown in FIG. 1 can be the EC devices described in the specification and shown in the other figures. The electrochromic film 103 may be used in various applications and/or in permutations, which may or may not be noted in the illustrative embodiments/aspects described herein. For instance, the electrochromic film 103 may include more or less features/components than those shown in FIG. 2, in some embodiments. Additionally, unless otherwise specified, one or more components of the electrochromic film 103 may be of conventional material, design, and/or fabricated using known techniques (e.g., sputtering, chemical vapor deposition (CVD), physical vapor deposition (PVD), plasma-enhanced chemical vapor deposition (PECVD), spray coating, slot-die coating, dip coating, spin coating, printing, etc.), as would be appreciated by skilled artisans upon reading the present disclosure.

In FIG. 2, the electrochromic film 103 may include a first transparent electrically conductive film 1312 and a second transparent electrically conductive film 1310. The first and second electrically conductive films 1312, 1310 may have the same or different dimensions, comprise the same or different material, etc. In some embodiments, the first and second transparent electrically conductive films may be adhesive films as shown in FIG. 1. In some other embodiments, the first and second transparent electrically conductive films may be additional films. The first and second electrically conductive films 1312, 1310 may also each independently have a single layer or multilayer structure. Suitable material for the first and second electrically conductive films 1312, 1310 may include, but is not limited to, tin doped indium oxide (ITO), fluorine doped indium oxide, antimony doped indium oxide, zinc doped indium oxide, aluminum doped zinc oxide, silver nano wire, metal mesh, combinations thereof, and/or other such transparent material exhibiting sufficient electrical conductance. In preferred aspects, the first and second electrically conductive films 1312, 1310 may comprise ITO.

As further shown in FIG. 2, a layer 1314 of electrochromic material is deposited on an interior surface 1316 of the first electrically conductive film 1312. The layer 1314 of electrochromic material is configured to effect a reversible color change upon reduction (gain of electrons) or oxidation (loss of electron) caused by an electrical current. In some embodiments, the layer 1314 of electrochromic material may be configured to change from a transparent state to a colored state, or from a colored state to another colored state, upon oxidation or reduction. In some embodiments, the layer 1314 of electrochromic material may be a polyelectrochromic material in which more than two redox states are possible, and may thus exhibit several colors.

In some embodiments, the layer 1314 of electrochromic material may comprise an organic electrochromic material, an inorganic electrochromic material, a mixture of both, etc. The layer 1314 of electrochromic material may also be a reduction colored material (i.e., a material that becomes colored upon acquisition of electrons), or an oxidation colored material (i.e., a material that becomes colored upon the loss of electrons).

In some embodiments, the layer 1314 of electrochromic material may include a metal oxide such as MoO₃, V₂O₅, Nb₂O₅, WO₃, TiO₂, Ir(OH)ₓ, SrTiO₃, ZrO₂, La₂O₃, CaTiO₃, sodium titanate, potassium niobate, combinations thereof, etc. In some embodiments, the layer 1314 of electrochromic material may include a conductive polymer such as poly-3,4-ethylenedioxy thiophene (PEDOT), poly-2,2′-bithiophene, polypyrrole, polyaniline (PANI), polythiopene, polyisothianaphthene, poly(o-aminophenol), polypyridine, polyindole, polycarbazole, polyquinone, octacyanophthalocyanine, combinations thereof, etc. Moreover, in some embodiments, the layer 1314 of electrochromic material may include materials, such as viologen, anthraquinone, phenocyazine, combinations thereof, etc. Additional examples of electrochromic materials, particularly those including multicolored electrochromic polymers, may be found in U.S. Pat. No. 9,975,989 B2, issued on May 22, 2018, titled Multicolored Electrochromic Polymer Compositions and Methods of Making and Using the Same. The entirety of the above-referenced application are herein incorporated by reference.

As additionally shown in FIG. 2, a charge storage layer 1318 is deposited on an interior surface 1320 of the second electrically conductive film 1310. Suitable materials for the charge storage layer 1318 may include, but are not limited to, vanadium oxide, binary oxides (e.g., CoO, IrO₂, MnO, NiO, and PrOₓ), ternary oxides (e.g., CeₓV_{y}O_{z}), etc.

In some embodiments, the charge storage layer 1318 may be replaced with an optional second layer of electrochromic material. This optional second layer of electrochromic material may have the same or different dimensions, comprise the same or different composition, etc., as the first layer 1314 of electrochromic material.

The electrochromic film 103 also includes an electrolyte layer 1322 positioned between the layer 1314 of electrochromic material and the charge storage layer 1318. In some embodiments, the electrolyte layer 1322 may include a liquid electrolyte as known in the art. In some embodiments, the electrolyte layer 1322 may include a solid state electrolyte, including but not limited to, Ta₂O₅, MgF, Li₃N, LiPO₄, LiBO₂—Li₂SO₄, etc. In some embodiments, the electrolyte layer 1322 may include a polymer based electrolyte comprising an electrolyte salt (e.g., LiTFSI, LiPF₆, LiBF₄, LiClO₄, LiCF₃SO₃, LiN(CF₃SO₂)₂, LiSbFg, LiAsF₆, LiN(CF₃CF₂SO₂)₂, (C₂H₅)₄NBF₄, (C₂H₅)₃CH₃NBF₄, LiI, etc.), a polymer matrix (e.g., polyethylene oxide, poly(vinylidene fluoride) (PVDF), poly(methyl methacrylate) (PMMA), polyethylene oxide (PEO), poly(acrylonitrile) (PAN), polyvinyl nitrile, etc.), and one or more optional plasticizers (e.g., glutaronitrile, succinonitrile, adiponitrile, fumaronitrile, etc.).

In some embodiments, the electrolyte layer 1322 comprises a solid polymer electrolyte. In one embodiment, the solid polymer electrolyte comprises a polymer framework, at least one solid plasticizer, and at least one electrolyte salt. In some embodiments, the polymer framework may include a polar polymer material having an average molecular weight of about 10,000 Daltons or greater. In particular embodiments, the polar polymer material may have an average molecular weight in a range from about 10,000 Daltons to about 800,000,000 Daltons. In some embodiments, the polar polymer material may be present in an amount ranging from about 15 wt. % to about 80 wt. % based on the total weight of the solid polymer electrolyte.

The aforementioned polar polymer material may include one or more polar polymers, each of which may include one or more of: C, N, F, O, H, P, F, etc. Suitable polar polymers may include, but are not limited to, polyethylene oxide, poly(vinylidene fluoride-hexafluoropropylene), poly(methyl methacrylate), polyvinyl nitrile, combinations thereof, etc. In embodiments where a plurality of polar polymers is present, the polymers may be crosslinked to form a network having enhanced mechanical properties.

The polar polymer material may have a sufficient amorphicity so as to achieve sufficient ion conductivity. Amorphous polymer materials typically exhibit high ion conductivities. Accordingly, in some embodiments, the polar material disclosed herein may have an amorphous, or a substantially amorphous, microstructure.

In some embodiments, the polar polymer material may have a semi-crystalline or crystalline microstructure. In such cases, various modifications may be implemented with respect to the polymer material to suppress the crystallinity thereof. For instance, one modification may involve use of branched polar polymers, linear random copolymers, block copolymers, comb polymers, and/or star-shaped polar polymers. Another modification may include incorporation of an effective amount of solid plasticizers in the polar polymer material, as discussed in greater detail below.

Various properties of the polar polymer material also may be selected and/or modified to maximize ion conductivity. These properties may include, but are not limited to, glass transition temperature, segmental mobility/flexibility of the polymer backbone and/or any side chains attached thereto, orientation of the polymers, etc.

As noted above, the presently disclosed solid electrolyte may include at least one solid plasticizer. The at least one solid plasticizer may be substantially miscible in the polymer framework of the solid plasticizer. The at least one solid plasticizer may include an organic material (e.g., small, solid organic molecules) and/or an oligomeric polymer material, in some embodiments. In various embodiments, the at least one solid plasticizer may be selected from the group including glutaronitrile, succinonitrile, adiponitrile, fumaronitrile, and combinations thereof.

In some embodiments, a plurality of solid plasticizers may be present in the polymer framework, where each plasticizer may independently include an organic material (e.g., small, solid organic molecules) and/or an oligomeric polymer material. Particularly, each plasticizer may independently be glutaronitrile, succinonitrile, adiponitrile, fumaronitrile, etc. Moreover, the dimensions of at least two, some, a majority, or all of the plasticizers may be the same or different as one another.

In some embodiments, the total amount of solid plasticizer may be in a range from about 20 wt. % to about 80 wt. % based on the total weight of the solid electrolyte.

As additionally noted above, the solid polymer electrolyte may include at least one electrolyte salt. In some embodiments, the at least one electrolyte salt may comprise an organic salt. In some embodiments, the at least one electrolyte salt may comprise an inorganic salt. Suitable electrolyte salts may include, but are not limited to, LiTFSI, LiPF₆, LiBF₄, LiClO₄, LiCF₃SO₃, LiN(CF₃SO₂)₂, LiSbFg, LiAsF₆, LiN(CF₃CF₂SO₂)₂, (C₂H₅)₄NBF₄, (C₂H₅)₃CH₃NBF₄, LiI, combinations thereof, etc. In some embodiments, the total amount of electrolyte salt may be in a range from about 10 wt. % to about 50 wt. % based on the total weight of the solid electrolyte.

The solid polymer electrolyte is distinguishable from conventional liquid electrolytes, as well as gel polymer electrolytes including an ionic liquid therein. In other words, the presently disclosed solid polymer electrolyte may be an all solid polymer electrolyte, and does not include any liquid or gel components therein. The presently disclosed solid polymer electrolyte may also be transparent in some aspects. Additionally, the solid polymer electrolyte may have an ion conductivity in a range from about 10⁻⁷ S/cm to about 10⁻³ S/cm.

Methods of making the presently disclosed solid polymer electrolyte may include synthesis, polymerization, solvation, etc. processes as known in the art. In one particular, non-limiting embodiment, a method of making the presently disclosed polymer electrolyte may include: (a) combining the polymer framework, the at least one plasticizer, and the at least one electrolyte salt in an appropriate solvent; and (b) removing the solvent to obtain the solid polymer electrolyte. Exemplary solvents may include, but are not limited to, acetone, methanol, tetrahydrofuran, etc. In some embodiments, one or more experimental parameters may be optimized to facilitate the dissolving of the polymer framework, plasticizer, and electrolyte salt in the solvent. These experimental parameters may include the components remain in the solvent, agitation/stirring of the solvent, etc.

In some embodiments, the electrolyte layer 1322 of FIG. 2 comprises a solid polymer electrolyte, such as the solid polymer electrolytes described above, and does not include any liquid or gel electrolyte. Such a solid polymer electrolyte (i) has sufficient mechanical strength yet is versatile in shape so as to allow easy formation into thin films, and thin-film shaped products; (ii) avoids issues related to adhesion and print processing affecting conventional electrolytes; (iii) provides stable contact between the electrolyte/electrode interfaces (those with and without the electrochromic material coating thereon); (iv) avoids the problem of leakage commonly associated with liquid electrolytes; (v) has desirable non-toxic and non-flammable properties; (vi) avoids problems associated with evaporation due to its lack of vapor pressure; (vii) exhibits improved ion conductivities as compared to convention polymer electrolytes; etc.

Additional examples of electrolyte materials, particularly those including solid polymer electrolytes, may be found in U.S. Pat. No. 10,597,518 B2, issued on Mar. 24, 2020, titled Solid Polymer Electrolyte for Electrochromic Devices. The entirety of the above-referenced application are herein incorporated by reference.

The electrolyte layer 1322 may provide ions for the electrochemical redox reaction in the electrochromic layer 1314. When an external power is applied, the ions move along the direction of an electric field generated by the external power. As such, the optical states of electrochromic material can be changed by injecting or extracting electric charges into the electrochromic materials. Both voltage driving and current driving can be employed to inject/extract electric charges. In addition, the combination of voltage driving and current driving can also be employed. Further, the voltage driving and the current driving can be operated at either direct current (DC) or alternating current (AC). As long as the required amount of electric charges are injected or extracted, the electrochromic material can be set at a certain optical state.

The dependence of the ion speed on the electric field can be described by the following Equation: v_{d}=μE, where v_{d} is the drift velocity of the ions, μ is the mobility of the ions, and E is the electric field. For example, when the driving power is an external voltage, a larger external voltage will generate a larger electric field, causing a higher speed of the mobile ions. In some embodiments, the external voltage may be increased to increase the ions' drift velocity. A higher ion's drift velocity may increase the rate of the redox reactions, thus shortening the transmission time between different optical states, e.g., lightness, transparency, color, reflectance, etc.

The external power polarity may depend on the electrochromic material. For p-type semiconductors that undergo p-doping (positively charged)/de-doping (neutralized) processes, for example, a positive external voltage V+, i.e., the electrode on the electrochromic material side is the anode, will change the electrochromic material from the neutral state to the p-doped state, while a negative external voltage V− will switch the electrochromic material from the p-doped state back to the neutral state. For n-type semiconductors that undergo n-doping (negatively charged)/de-doping (neutralized) processes, a negative external voltage V−, i.e. the electrode on the electrochromic material side is the cathode, will change the electrochromic material from the neutral state to the n-doped state, while a positive external voltage V+ will switch the electrochromic material from the n-doped state back to the neutral state. At the neutral state, the electrochromic material could be in either dark state or clear state. Similarly, at the doped state, the electrochromic material could be in either dark state or clear state. For simplicity, this disclosure describes an external voltage as an exemplary driving power. The conclusions and inventions disclosed herein are applicable to both current driving and combination of voltage driving and current driving. The description herein is not intended to be exhaustive or to limit the invention to the precise forms disclosed.

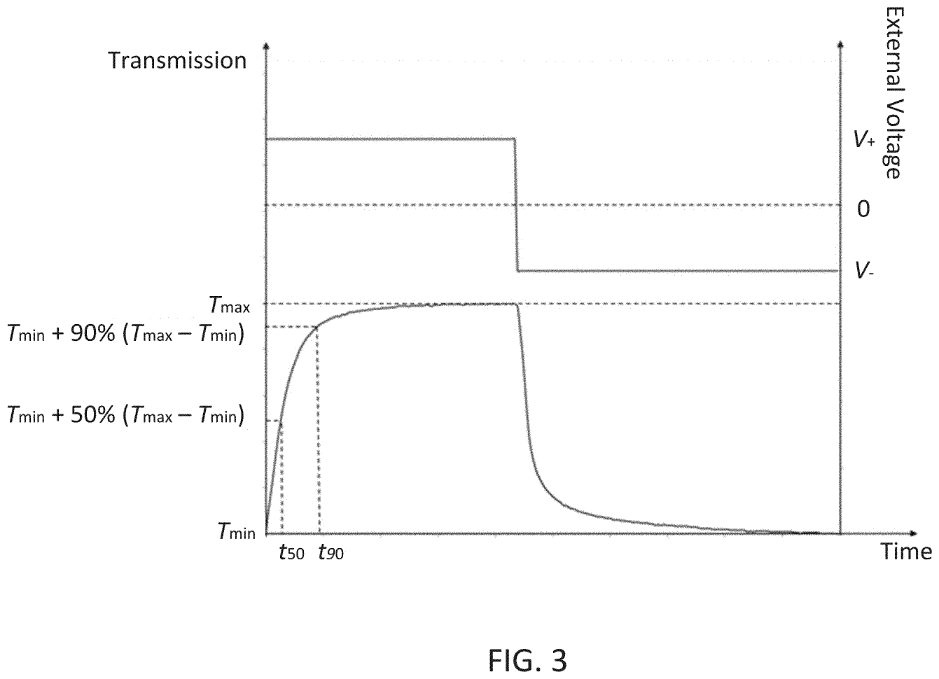

FIG. 3 represents a transmission of an electrochromic (EC) device over time under an external voltage, consistent with exemplary embodiments of the present disclosure. The lower graph shows the transmission of the EC device as a function of time, and the upper graph shows the applied external voltage on the EC device as a function of time. As an example, the electrochromic material in FIG. 3 is a p-type semiconductor whose neutral state is dark. Here, the absolute values of the external voltages V+ and V− are not necessarily the same. In some embodiments, the absolute values of V+ and V− are the same. In some embodiments, the absolute value of V+ is higher than the absolute value of V−. In some embodiments, the absolute value of V− is higher than the absolute value of V+.

As shown in FIG. 3, with the application of a positive voltage V+, the EC device transfers from a dark state to a clear state. In some embodiments, an initial optical state in which the transmission is the minimum, i.e., the dark state, is designated by Tₘᵢₙ, and a desired optical state in which the transmission reaches the maximum is designed by Tₘₐₓ. To characterize the transmission speed of an EC device, two figures of merit are generally used, i.e. t₅₀ and t₉₀. Here, t₅₀ is the time for the EC device transferring from the dark state (Tₘᵢₙ) to a state in which the transmission is half between Tₘᵢₙ and Tₘₐₓ, i.e. Tₘᵢₙ+50% (Tₘₐₓ−Tₘᵢₙ); and t₉₀ is the time for the EC device transferring from the dark state (Tₘᵢₙ) to a state in which the transmission reaches 90% of the dynamic range, i.e. Tₘᵢₙ+90% (Tₘₐₓ−Tₘᵢₙ). The transmission curve in FIG. 3 shows a sharp “turn-on” slope. The EC device starts the transmission from a dark state, and the transmission quickly reaches 90% of the dynamic range in a short time t₉₀, and then gradually saturates to its maximum Tₘₐₓ.

Similarly, to characterize the transmission speed of the EC device transferring from the clear state (Tₘₐₓ) to the dark state (Tₘᵢₙ), a second set of t′₅₀ and t′₉₀ can be defined as t′₅₀=Tₘₐₓ−50% (Tₘₐₓ−Tₘᵢₙ), and t′₉₀=Tₘₐₓ−90% (Tₘₐₓ−Tₘᵢₙ). For clarification and convenience of the description, this disclosure focuses on the transmission from the dark state to the clear state of the a p-type electrochromic material whose neutral state is dark. However, those skilled in the art should know that the present disclosure is not limited to the EC device described herein. The conclusions and inventions disclosed herein are applicable to both dark-to-clear and clear-to-dark state transmission processes, and applicable to both p-type and n-type electrochromic materials. It is not intended to be exhaustive or to limit the invention to the precise forms disclosed. The breadth and scope of the present invention should not be limited by any of the above-described exemplary embodiments.

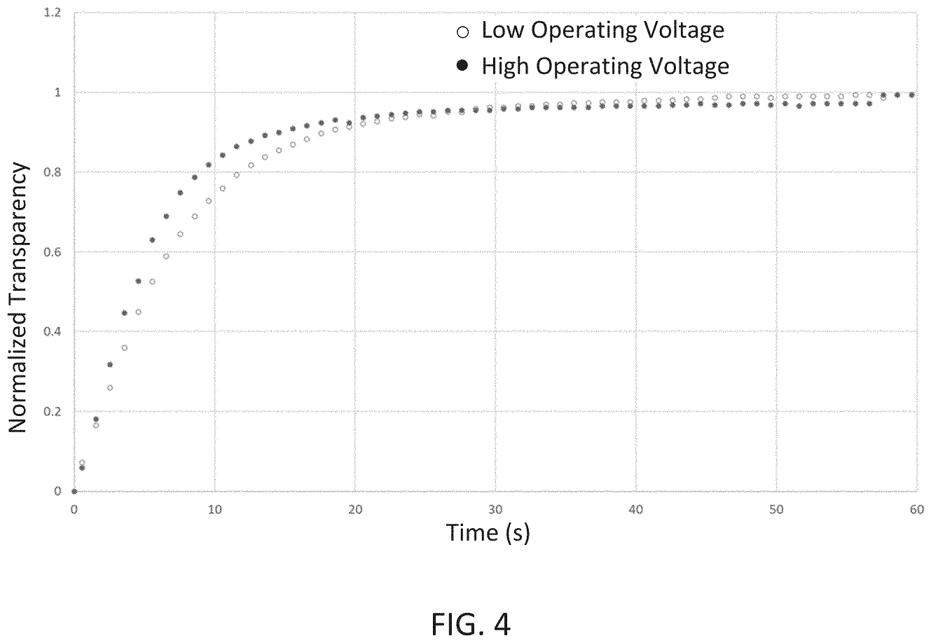

FIG. 4 illustrates an exemplary EC device transferring from a dark state to a clear state over time under two different external voltages, consistent with exemplary embodiments of the present disclosure. As shown in FIG. 4, under a lower operating voltage (i.e., external voltage), the t₅₀ and t₉₀ are around 5 s, and 18 s, respectively. Under a higher operating voltage, the t₅₀ and t₉₀ are around 4 s, and 15 s, respectively. Comparing the transmission speed under the two different external voltages, t₅₀ is shortened by 1 s with a 20% improvement, while t₉₀ is shortened by 3 s with a 17% improvement. Therefore, by increasing the external voltage, the transmission speed of an EC device can be increased. In some embodiments, for the human visual response, human eyes are more sensitive to the onset of the optical state change. Therefore, the initial state change is more critical for users to appreciate the transmission speed, thus, t₅₀ is more important than t₉₀ to give a user an impression of a “fast/slow” transmission.

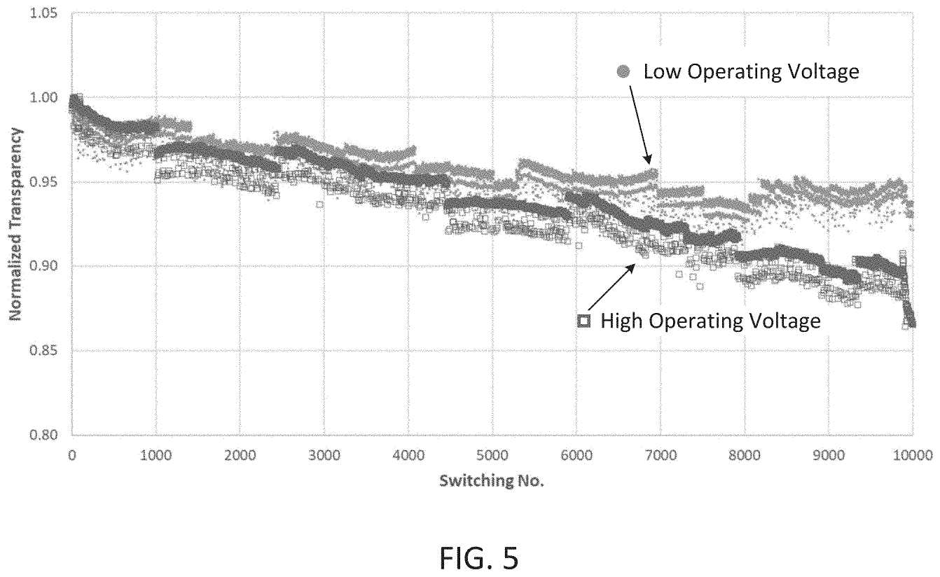

In some embodiments, a large operating voltage may damage the stability of an EC device. The lifetime of the EC device may be reduced by the high external voltage. To characterize an EC device's stability of transmission, the transmission of the EC device may be monitored by continuously cycling the EC device from its dark state to its clear state and then back to the dark state. One full transmission switching cycle may be defined as the EC device transferring from its dark state to its clear state and then back to the dark state. FIG. 5 illustrates transmission data of an exemplary EC device in a plurality of switching cycles under two different external voltages, consistent with exemplary embodiments of the present disclosure. As shown in FIG. 5, the transparency of the EC device is normalized to its initial value, i.e., the transparency manifested in the first full switching cycle. The EC device shows its maximum transmission in the first full switching cycle. As the number of switching cycles increases, the transmission under both external voltages gradually decreases. After 10,000 switching cycles, the clear state's transmission drops around 6% of the initial value under a lower operating voltage (i.e., external voltage), and the transmission drops around 12% of the initial value under a higher operating voltage. The percentage drop under the higher operating voltage is about twice of the drop under the lower operating voltage. Therefore, in some embodiments, a constant operation under a higher external voltage may gradually reduce the transmission of the EC device compared with a constant operation under a lower external voltage. Thus, operation under the higher external voltage may reduce the stability of an EC device.

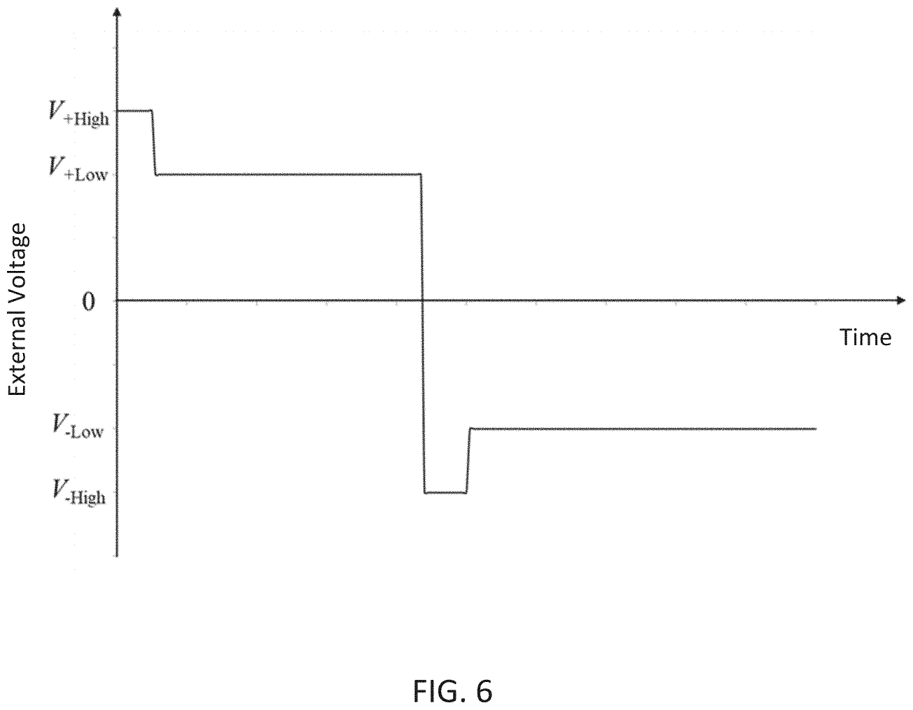

In view of above, the present disclosure provides a method of both increasing the transmission speed and improving the transmission stability of an EC device. FIG. 6 is a schematic diagram of controlling an external power to the EC device according to an exemplary embodiment. As shown in FIG. 6, external voltages are applied as the external power as an example. In some embodiments, the external power may be an external current. In some other embodiments, the external power may be a combination of external voltage and external current. This disclosure is not limited to one or more embodiments described herein.

FIG. 6 illustrates an exemplary external voltage waveform applied to an EC device, consistent with exemplary embodiments of the present disclosure. To achieve an optical state transmission of an EC device from an initial optical state to a desired optical state, a combination of different operating voltages (i.e., external voltages) is applied to the EC device, shown as the waveform in FIG. 6. In some embodiments, the operating voltage may start with a higher voltage V+_{High} followed by a lower voltage V+_{Low}. The higher voltage V+_{High} may be applied to the EC device for a first period of time and the lower voltage V+_{Low} may be applied to the EC device for a second period of time. In some embodiments, a higher operating voltage V+_{High} may be applied to initiate the transmission of the EC device. A higher initial voltage V+_{High} may introduce a higher transmission speed which may provide users with a “fast” impression. In some embodiments, as the transmission curve shows a sharp “turn-on” slope, the initial higher voltage V+_{High} may only need to be kept for a short period of time. i.e., the first period of time. After the transmission reaches a specific value, the operating voltage may be then switched to a lower voltage V+_{Low}. Since the lower voltage V+_{Low} will drive the EC device most of the time, i.e., the second period of time, the stress on the stability of the EC device introduced by the initial higher voltage V+_{High} may be extenuated, and even can be negligible.

In some embodiments, the specific transmission value may be half between Tₘᵢₙ and Tₘₐₓ, i.e. Tₘᵢₙ+50% (Tₘₐₓ−Tₘᵢₙ). Then at t₅₀, the operating voltage is switched from its initial higher voltage V+_{High} to a lower voltage V+_{Low}. Thus, the first period of time may be the same as t₅₀. In other embodiments, the specific transmission value may be 90% of the dynamic range, i.e. Tₘᵢₙ+90% (Tₘₐₓ−Tₘᵢₙ). Then at t₉₀, the operating voltage is switched from its initial higher voltage V+_{High} to a lower voltage V+_{Low}. Thus, the first period of time may be the same as t₉₀. In some other embodiments, the specific transmission value can be determined by a user based on the user's requirement. According to a relationship between the EC device's transmission values and the transmission time, which can be summarized in a table or plotted in a graph (e.g., FIG. 3), the corresponding switching time can be determined to switch the operating voltage from a higher voltage V+_{High} to a lower voltage V+_{Low}. Thus, the first period of time may be determined based on the voltage switching time. The second period of time may be not the same as the first period of time. In some embodiments, the second period of time may be longer than the first period of time. In some embodiments, the second period of time may be not a constant number. In some embodiments, the second period of time may be determined based on the user's requirement.

Similarly, a combination of operating voltages V−_{High} and V−_{Low} may be applied to cause the EC device to transfer from the clear state (Tₘₐₓ) to the dark state (Tₘᵢₙ). As shown in FIG. 6, a higher operating voltage V−_{High} is applied to initiate the transmission to enable a “fast” transmission speed. Once the transmission reaches a second specific value, the operating voltage may be switched to a lower operating voltage V−_{Low} to maintain the stability of the EC device. During this process, a second set of t′₅₀ and t′₉₀ may be defined as t′₅₀=Tₘₐₓ−50% (Tₘₐₓ−Tₘᵢₙ), and t′₉₀=Tₘₐₓ−90% (Tₘₐₓ−Tₘᵢₙ). In some embodiments, t′₅₀ is selected as a time to switch the operating voltage from the higher voltage V−_{High} to the lower voltage V−_{Low}. In another embodiment, t′₉₀ is selected as a time to switch the operating voltage from the higher voltage V−_{High} to the lower voltage V−_{Low}. In another embodiment, the second specific transmission value and the operating voltage switch time can be determined by a user based on the user's requirement.

In some embodiments, the absolute values (i.e., magnitudes) of V+_{High} and V−_{High} are not necessarily the same, and/or the absolute values of V+_{Low} and V−_{Low} are not necessarily the same, either. In some embodiments, the absolute values of V+_{High} and V−_{High} are the same; and/or the absolute values of V+_{Low} and V−_{Low} are the same. In one embodiment, the absolute value of V+_{High} is higher than the absolute value of V−_{High}; and/or the absolute value of V+_{Low} is higher than the absolute value of V−_{Low}. In another embodiment, the absolute value of V−_{High} is higher than the absolute value of V+_{High}; and/or the absolute value of V−_{Low} is higher than the absolute value of V+_{Low}. In some embodiments, the external voltage may be switched to one or more additional values after applying the lower voltage for a second period of time. For example, after applying the higher voltage for a first period of time and a subsequent lower voltage for a second period of time, a third voltage may be applied to the EC device for a third period of time. In some embodiments, a fourth voltage may be further applied for a fourth period of time. The absolute values and time of application of the one or more additional external voltages may be determined based on the features of the EC device and/or the user's requirement. Those skilled in the art should know that the present disclosure is not limited to the EC device and the specific method described herein.

In one embodiment, the absolute value (i.e., magnitude) of the external voltage may be determined based on the characteristics of the EC device, such as, the electrochromic materials, the electrochemical window, the transmission stability, etc. In another embodiment, the absolute value (i.e., magnitude) of the external voltage may be determined based on the user's requirement, such as, the transmission speed, the EC device's durance at the dark/clear state, the expected life span of the EC device, etc. In yet another embodiment, a relationship of an EC device's transmission as a function of time under different external voltages can be predetermined, and plotted in a graph or summarized in a table. Based on the relationship, the external voltage can be determined based on the desired transmission value/time, or vice versa.

In some embodiments, the absolute values (i.e., magnitudes) of V+_{High}, V−_{High}, V+_{Low} and V−_{Low} are constant values. In some embodiments, the absolute values of V+_{High}, V−_{High}, V+_{Low} and V−_{Low} may vary as a function of time. For example, the absolute values may gradually increase/decrease as a function of time. In some embodiments, the absolute values may be modulated as a sine/cosine function. In some embodiments, the absolute values may be determined and/or varied based on the user's requirement. In some embodiments, the absolute values may be changed due to the number of switching cycles increases.

In some embodiments, the optical states of electochromic materials can be changed by injecting or extracting electric charges into the electrochromic films. Both voltage driving and current driving can be employed to inject/extract electric charges. In addition, the combination of voltage driving and current driving can also be employed. In some embodiments, the voltage driving and the current driving can be operated at either direct current (DC) or alternating current (AC). As long as the required amount of electric charges are injected or extracted, the electrochromic film can be set at a certain optical state.

For clarification and convenience of the description, this disclosure focuses on the transmission from the dark state to the clear state of the a p-type electrochromic material whose neutral state is dark. An external voltage is used as an exemplary external power to drive the state transmission of an EC device. However, those skilled in the art should know that the present disclosure is not limited to the EC device and the specific method described herein. It is not intended to be exhaustive or to limit the invention to the precise forms disclosed. The breadth and scope of the present invention should not be limited by any of the above-described exemplary embodiments.

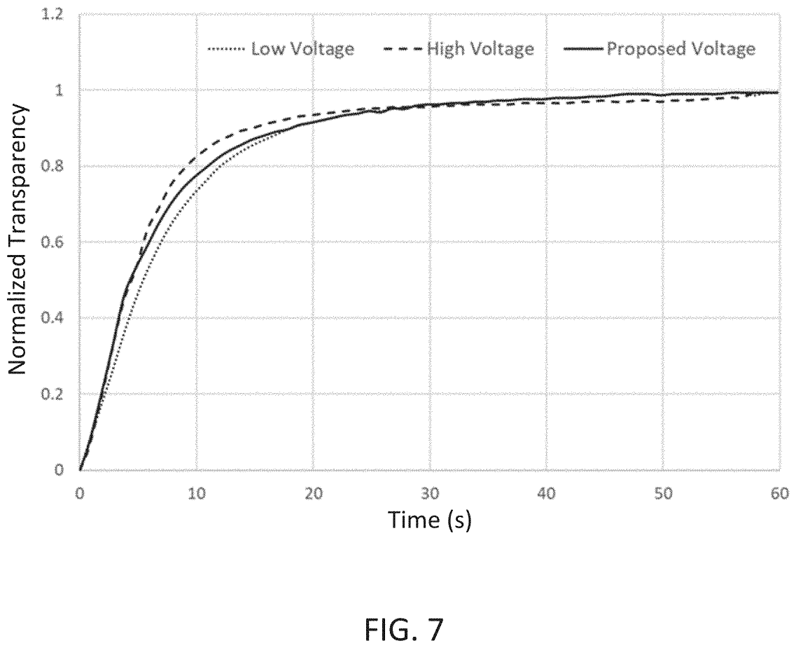

FIG. 7 presents an exemplary EC device transferring from a dark state to a clear state under a low operating voltage, a high operating voltage and a proposed voltage (i.e., a combination of the higher and lower external voltages), respectively, consistent with exemplary embodiments of the present disclosure. In FIG. 7, the transparency of the EC device as a function of time is normalized to the maximum value of the transparency. For the proposed voltage, the operating voltage starts with a higher voltage, and when the time reaches t₅₀, the operating voltage switches to a lower voltage value. As shown in FIG. 7, the transmission under the proposed voltage initially follows the transmission under the high operating voltage. When the time reaches t₅₀ in the transmission curve of the high operating voltage, the proposed voltage is switched to the lower voltage. The transmission under the proposed voltage then starts merging into the curve of the low operating voltage. In FIG. 7, the proposed voltage includes a higher voltage with a time period of 4 seconds and a lower voltage with a time period of 56 seconds. The stability of the EC device under the proposed voltage is tested by continuously switching the EC device as described earlier. After 10,000 cycles, the drop of the clear state's transmission is around 6%, the same as the drop by using the low operating voltage alone. Therefore, by combing a higher voltage and a lower voltage as an operating voltage, the EC device obtains a larger transmission speed and also maintain its transmission stability.

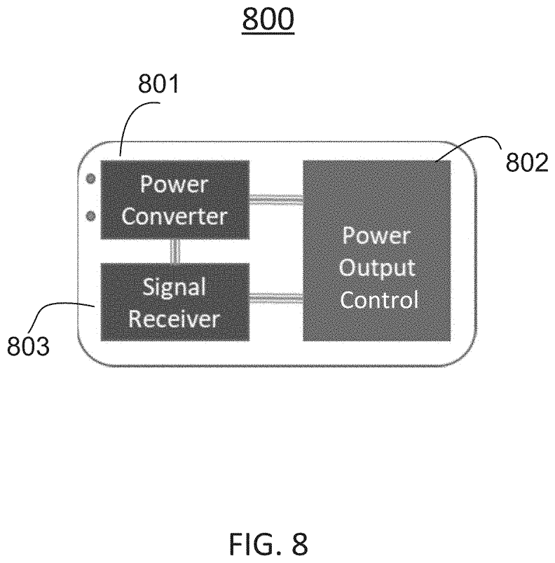

The present disclosure also provides a controller for controlling optical state transmissions of an EC device according to an embodiment of the present application. FIG. 8 is a graphical presentation illustrating a controller 800, consistent with exemplary embodiments of the present disclosure. The controller 800 may include a power converter 801, a power output control 802, and a signal receiver 803. The power converter 801 may convert input power (e.g., electrical energy) from a power source to the power required by the signal receiver 803 and the power output control 802. The power converter 801 can act as a link or the transforming stage between the power source and the power output control 802. In some embodiments, a power converter 801 can convert alternating current (AC) into direct current (DC) and vice versa; change the voltage or frequency of the current, etc. The power source could be either a power source integrated with the controller 800 as a self-contained, self-powered unit, or an external power source, provided by, for example, power of a building where the electrochromic device is installed. The power output control 802 may be configured to receive the power provided by the power converter 801 and output power to the electrochromic film 103. For example, the power output control 802 may be configured to output voltage between the first and second electrically conductive films 1312, 1310. Since the state of the electrochromic film 103 is driven by electric charges, the power output control 802 can inject into or extract a certain amount of electric charges from the electrochromic film 103 based on the signals the signal receiver 803 receives, in order to change the state of the electrochromic film 103. In some embodiments, the power output control 802 can be configured to output variable voltages to the EC device. In some embodiments, the power output control 802 may continuously adjust the power output to the EC device with phase, cycle, magnitude, and/or on/off control. In some embodiments, the power output control 802 can be programmable. In some embodiments, the power output control 802 can be manually set. The signal receiver 803 may be configured to receive signals sent to the controller 800, and transfer the signals to the power output control 802. In some embodiments, the signal receiver 803 may be connected to an external switch and a central switch to provide both local and global controls of the EC device 100.

To achieve an optical state transmission of an EC device from an initial optical state to a desired optical state, the power output control 802 may be configured to provide driving power to the EC device. In some embodiments, the provided driving power may be a combination of voltages. In some embodiments, the power output control 802 is configured to provide the combination of voltages to an EC device for transferring from a dark state to a clear state. The combination of voltages may include a higher operating voltage V+_{High} and a lower operating voltage V+_{Low}. The absolute value (i.e., magnitude) of the higher operating voltage is larger than the absolute value of the lower operating voltage. In some embodiments, the power output control 802 is configured to apply the higher operating voltage to the EC device for a first period of time and apply the lower operating voltage to the EC device for a second period of time. In one embodiment, the first period of time is the same as t₅₀. Here, t₅₀ is the time for the EC device transferring from the dark state (Tₘᵢₙ) to a state in which the transmission is half between Tₘᵢₙ and Tₘₐₓ, i.e. Tₘᵢₙ+50% (Tₘₐₓ−Tₘᵢₙ). In another embodiment, the first period of time is the same as t₉₀. Here, t₉₀ is the time for the EC device transferring from the dark state (Tₘᵢₙ) to a state in which the transmission reaches 90% of the dynamic range, i.e. Tₘᵢₙ+90% (Tₘₐₓ−Tₘᵢₙ).

The present disclosure also provides an EC device with a controller for controlling optical state transmissions of the EC device according to an embodiment of the present application. In some embodiments, the EC device may be dynamic glass. To achieve an optical state transmission of the dynamic glass from an initial optical state to a desired optical state, the controller may be configured to provide driving power to the dynamic glass. In some embodiments, the provided driving power may be a combination of voltages. In some embodiments, the controller is configured to provide the combination of voltages to the dynamic glass for transferring from a dark state to a clear state. The driving power may include a higher operating voltage V+_{High} and a lower operating voltage V+_{Low}. The absolute value (i.e., magnitude) of the higher operating voltage is larger than the absolute value of the lower operating voltage. In some embodiments, the controller is configured to apply the higher operating voltage to the dynamic glass for a first period of time and apply the lower operating voltage to the dynamic glass for a second period of time. In one embodiment, the first period of time is the same as t₅₀. Here, t₅₀ is the time for the dynamic glass transferring from the dark state (Tₘᵢₙ) to a state in which the transmission is half between Tₘᵢₙ and Tₘₐₓ, i.e. Tₘᵢₙ+50% (Tₘₐₓ−Tₘᵢₙ). In another embodiment, the first period of time is the same as t₉₀. Here, t₉₀ is the time for the dynamic glass transferring from the dark state (Tₘᵢₙ) to a state in which the transmission reaches 90% of the dynamic range, i.e. Tₘᵢₙ+90% (Tₘₐₓ−Tₘᵢₙ).

It should be noted that this controller and device embodiments correspond to the aforementioned method embodiment. For ease of reading, the controller and device embodiments will not go over each detail given in the aforementioned method embodiment, but it should be clear that the controller and device of these embodiments are capable of achieving everything achieved in the aforementioned method embodiment.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method of changing an optical state of an electrochromic device, comprising:
selecting a desired optical state of the electrochromic device;
determining a driving power to change the optical state based on an initial state and the desired state of the electrochromic device, wherein the driving power comprises a first magnitude and a second magnitude, and the first magnitude is larger than the second magnitude;
applying the driving power with the first magnitude to the electrochromic device for a period of time t; and
at time t, switching the driving power to the second magnitude.

2. The method of claim 1, wherein the initial optical state is a dark state having a minimum transmission Tₘᵢₙ, the desired optical state is a clear state having a maximum transmission Tₘₐₓ, and the period of time t is a time when a transmission of the electrochromic device equals Tₘᵢₙ+50% (Tₘₐₓ−Tₘᵢₙ).

3. The method of claim 1, wherein the initial optical state is a dark state having a minimum transmission Tₘᵢₙ, the desired optical state is a clear state having a maximum transmission Tₘₐₓ, and the period of time t is a time when a transmission of the electrochromic device equals Tₘᵢₙ+90% (Tₘₐₓ−Tₘᵢₙ).

4. The method of claim 1, wherein the initial optical state is a clear state having a maximum transmission Tₘₐₓ, the desired optical state is a dark state having a minimum transmission Tₘᵢₙ, and the period of time t is a time when a transmission of the electrochromic device equals Tₘₐₓ−50% (Tₘₐₓ−Tₘᵢₙ).

5. The method of claim 1, wherein the initial optical state is a clear state having a maximum transmission Tₘₐₓ, the desired optical state is a dark state having a minimum transmission Tₘᵢₙ, and the period of time t is a time when a transmission of the electrochromic device equals Tₘₐₓ−90% (Tₘₐₓ−Tₘᵢₙ).

6. The method of claim 1, wherein the period of time t is determined based on a transmission of the electrochromic device, and the method further comprises:
monitoring the transmission of the electrochromic device; and
when the transmission of the electrochromic device reaches a preset value, switching the driving power from the first magnitude to the second magnitude.

7. The method of claim 1, wherein the driving power comprises a voltage, a current, or a combination thereof.

8. A controller for changing an optical state of an electrochromic device, comprising:
a signal receiver configured to receive signals sent to the controller;
a power converter configured to convert an input power from a power source to a power required by the signal receiver; and
a power output control configured to receive the converted power from the power converter and provide a driving power to the electrochromic device to change the optical state of the electrochromic device from an initial state to a desired state, wherein the driving power comprises a first magnitude and a second magnitude, the first magnitude is larger than the second magnitude, and, to provide a driving power, the power output control is further configured to:
apply the driving power with the first magnitude to the electrochromic device for a period of time t; and
at time t, switch the driving power to the second magnitude.

9. The controller of claim 8, wherein the initial optical state is a dark state having a minimum transmission Tₘᵢₙ, the desired optical state is a clear state having a maximum transmission Tₘₐₓ, and the period of time t is a time when a transmission of the electrochromic device equals Tₘᵢₙ+50% (Tₘₐₓ−Tₘᵢₙ).

10. The controller of claim 8, wherein the initial optical state is a dark state having a minimum transmission Tₘᵢₙ, the desired optical state is a clear state having a maximum transmission Tₘₐₓ, and the period of time t is a time when a transmission of the electrochromic device equals Tₘᵢₙ+90% (Tₘₐₓ−Tₘᵢₙ).

11. The controller of claim 8, wherein the initial optical state is a clear state having a maximum transmission Tₘₐₓ, the desired optical state is a dark state having a minimum transmission Tₘᵢₙ, and the period of time t is a time when a transmission of the electrochromic device equals Tₘₐₓ−50% (Tₘₐₓ−Tₘᵢₙ).

12. The controller of claim 8, wherein the initial optical state is a clear state having a maximum transmission Tₘₐₓ, the desired optical state is a dark state having a minimum transmission Tₘᵢₙ, and the period of time t is a time when a transmission of the electrochromic device equals Tₘₐₓ−90% (Tₘₐₓ−Tₘᵢₙ).

13. The controller of claim 8, wherein the period of time t is determined based on a transmission of the electrochromic device, and the power output control is configured to: when the transmission of the electrochromic device reaches a preset value, switch the driving power from the first magnitude to the second magnitude.

14. The controller of claim 8, wherein the driving power comprises a voltage, a current, or a combination thereof.

15. An electrochromic device, comprising:
two transparent substrates;
two adhesive layers disposed on inner surfaces of the two transparent substrates;
an electrochromic film disposed between the two adhesive layers, the electrochromic film including an electrochromic material layer, a solid polymer electrolyte, and a charge storage layer; and
a controller configured to provide a driving power to the electrochromic device to change an optical state of the electrochromic device from an initial state to a desired state, wherein the driving power comprises a first magnitude and a second magnitude, the first magnitude is larger than the second magnitude, and, to provide a driving power, the controller is configured to:
apply the driving power with the first magnitude to the electrochromic device for a period of time t; and
at time t, switch the driving power to the second magnitude.

16. The electrochromic device of claim 15, wherein the initial optical state is a dark state having a minimum transmission Tₘᵢₙ, the desired optical state is a clear state having a maximum transmission Tₘₐₓ, and the period of time t is a time when a transmission of the electrochromic device equals Tₘᵢₙ+50% (Tₘₐₓ−Tₘᵢₙ).

17. The electrochromic device of claim 15, wherein the initial optical state is a dark state having a minimum transmission Tₘᵢₙ, the desired optical state is a clear state having a maximum transmission Tₘₐₓ, and the period of time t is a time when a transmission of the electrochromic device equals Tₘᵢₙ+90% (Tₘₐₓ−Tₘᵢₙ).

18. The electrochromic device of claim 15, wherein the initial optical state is a clear state having a maximum transmission Tₘₐₓ, the desired optical state is a dark state having a minimum transmission Tₘᵢₙ, and the period of time t is a time when a transmission of the electrochromic device equals Tₘₐₓ−50% (Tₘₐₓ−Tₘᵢₙ).

19. The electrochromic device of claim 15, wherein the initial optical state is a clear state having a maximum transmission Tₘₐₓ, the desired optical state is a dark state having a minimum transmission Tₘᵢₙ, and the period of time t is a time when a transmission of the electrochromic device equals Tₘₐₓ−90% (Tₘₐₓ−Tₘᵢₙ).

20. The electrochromic device of claim 15, wherein the driving power comprises a voltage, a current, or a combination thereof.
